(19) United States
(12) Patent Application Publication
(10) Pub. No.: US 2026/0291590 A1
(43) Pub. Date: Sep. 24, 2026

(54) Sidelink Operation Enhancements

(71) Applicant: Apple Inc., Cupertino, CA (US)

(72) Inventors: Chunxuan Ye, San Diego, CA (US); Dawei Zhang, Saratoga, CA (US); Haitong Sun, Saratoga, CA (US); Hong He, San Jose, CA (US); Huaning Niu, San Jose, CA (US); Oghenekome Oteri, San Diego, CA (US); Wei Zeng, Saratoga, CA (US)

(21) Appl. No.: 19/476,435

(22) PCT Filed: May 10, 2024
(86) PCT No.: PCT/US2024/028703

§ 371 Date: Oct. 17, 2025

Related U.S. Application Data
(60) Provisional application No. 63/501,993, filed on May 12, 2023.

(51) Int. Cl. H04B 7/06

(52) U.S. Cl. CPC H04B 7/06954; H04B 7/0696

(57) ABSTRACT

Apparatuses, systems, and methods for sidelink operation enhancements, e.g., in 5G NR systems and beyond. A UE may determine to set up a sidelink unicast link with a neighboring UE in a first slot. The UE may transmit, during a transmission window for transmitting beam pairing reference signals, beam pairing reference signals to the neighboring UE for beam pairing. The transmission window may be defined based on the first slot. The UE may perform beam pairing with the neighboring UE, e.g., based, at least in part, on the beam pairing reference signals.

### FIELD

The invention relates to wireless communications, and more particularly to apparatuses, systems, and methods for sidelink operation enhancements, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for sidelink operation enhancements, e.g., in 5G NR systems and beyond.

For example, in some embodiments, a UE may be configured to determine to set up a sidelink unicast link with a neighboring UE in a first slot. Further, the UE may be configured to transmit, during a transmission window for transmitting beam pairing reference signals, beam pairing reference signals to the neighboring UE for beam pairing. The transmission window may be defined based on the first slot. In addition, the UE may be configured to perform beam pairing with the neighboring UE, e.g., based, at least in part, on the beam pairing reference signals.

As another example, in some embodiments, a UE may be configured to transmit a sidelink physical channel carrying unicast link establishment messages. The sidelink physical channel may be at least one of a PSCCH or a PSSCH. In addition, the UE may be configured to transmit sidelink reference signals for beam management. The sidelink reference signals for beam management may be transmitted on the same beams used to transmit the sidelink physical channel. Further, the UE may be configured to receive, from a neighboring UE, beam reporting.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system according to some embodiments.

FIG. 2 illustrates an example block diagram of a base station, according to some embodiments.

FIG. 3 illustrates an example block diagram of a server, according to some embodiments.

FIG. 4 illustrates an example block diagram of a UE, according to some embodiments.

FIG. 5 illustrates an example of a 5G network architecture that incorporates both dual 3GPP (e.g., LTE and 5G NR) access and non-3GPP access to the 5G CN, according to some embodiments.

FIG. 6A illustrates an example of SL CSI-RS transmissions occupying all of a resource pool, according to some embodiments.

FIG. 6B illustrates an example of an SL CSI-RS transmission occupying a portion of a resource pool and another portion of the resource pool being occupied by PSCCH/PSSCH, according to some embodiments.

FIGS. 7A, 7B, and 7C illustrate examples of correspondence of dedicated slots for beam sweeping to dedicated slots for beam reporting, according to some embodiments.

FIG. 8 illustrates an example of receiving UEs using PSFCH based beam reporting for SL CSI-RS based beam sweeping, according to some embodiments.

FIG. 9A illustrates an example of a receiving UE using PSCCH/PSSCH based beam reporting for SL CSI-RS based beam sweeping, according to some embodiments.

FIG. 9B illustrates an example of a receiving UE using PSCCH/PSSCH based beam reporting for S-SSB based beam sweeping, according to some embodiments.

FIG. 10A illustrates a block diagram of an example of a method for triggering and de-activation of SL reference signal beam forming transmissions for initial beam pairing when beam pairing is before unicast link establishment, according to some embodiments.

FIG. 10B illustrates a block diagram of an example of a method for triggering and de-activation of SL reference signal beam forming transmissions for initial beam pairing when beam pairing is during unicast link establishment, according to some embodiments.

FIG. 11 illustrates a block diagram of an example of a method for triggering and de-activation of SL BFR reference signals, according to some embodiments.

FIG. 12 illustrates a block diagram of an example of a method for initial beam pairing prior to set up of a sidelink unicast link, according to some embodiments.

FIG. 13 illustrates a block diagram of an example of a method for initial beam pairing during set up of a sidelink unicast link, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
PDCCH: Physical Downlink Control Channel
PDSCH: Physical Downlink Shared Channel
RRC: Radio Resource Control

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non- 3GPP accesses interwork with the EPC/ 5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

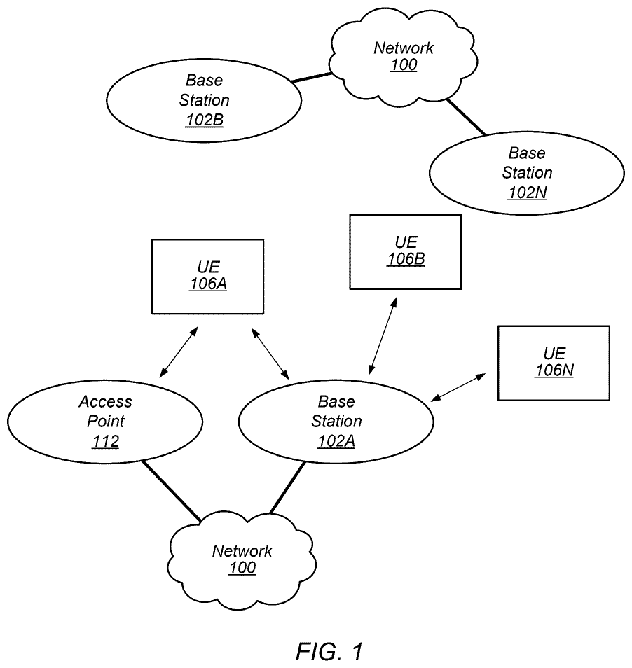

### FIG. 1: Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

In addition, the UE 106 may be in communication with an access point 112, e.g., using a wireless networking (e.g., Wi-Fi) and/or peer-to-peer wireless communication protocol (e.g., Bluetooth, Wi-Fi peer-to-peer, etc.). The access point 112 may provide a connection to the network 100.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

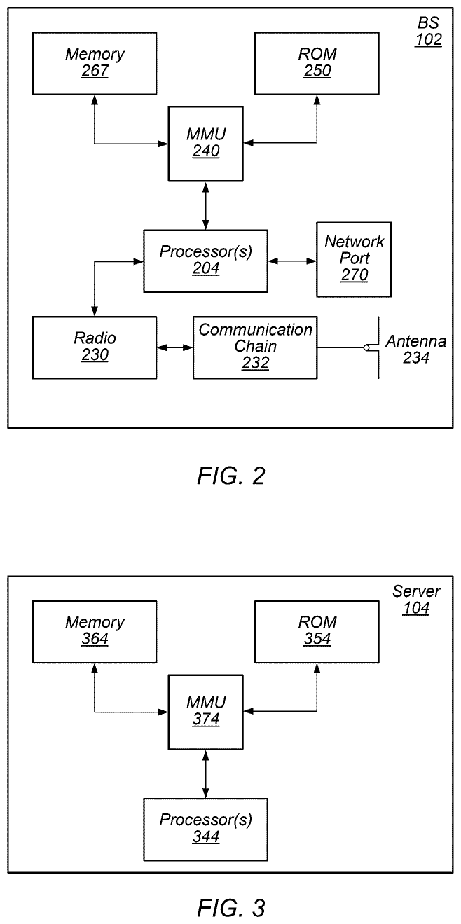

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

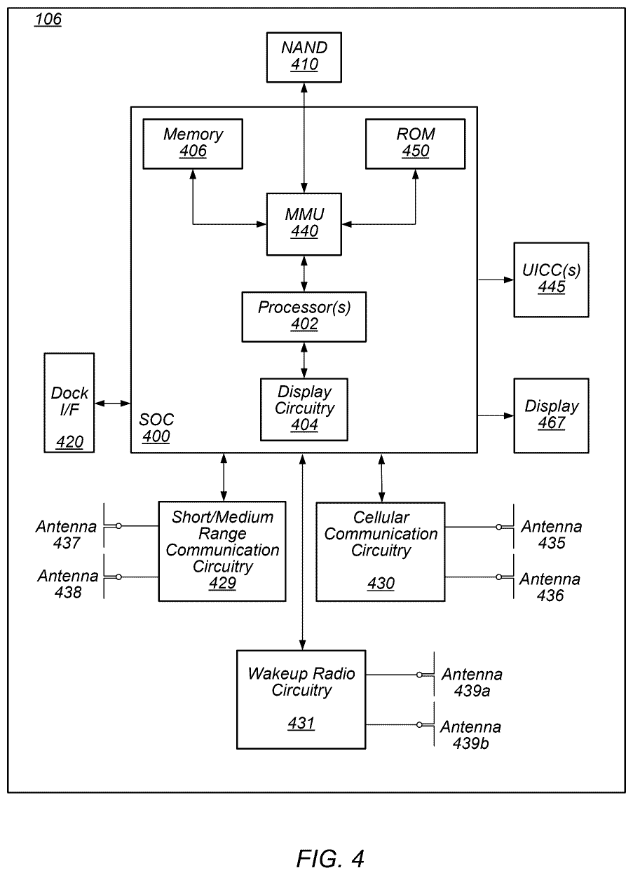

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., short to medium range wireless communication circuitry 429 (e.g., Bluetooth™ and WLAN circuitry), and wakeup radio circuitry 431. In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The wakeup radio circuitry 431 may also couple (e.g., communicatively; directly or indirectly) to one or more antennas, such as antennas 439a and 439b as shown. Alternatively, the wakeup radio circuitry 431 may couple (e.g., communicatively; directly or indirectly) to the antennas 435 and 436 in addition to, or instead of, coupling (e.g., communicatively; directly or indirectly) to the antennas 439a and 439b. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration. The wakeup radio circuitry 431 may include a wakeup receiver, e.g., wakeup radio circuitry 431 may be a wakeup receiver. In some instances, wakeup radio circuitry 431 may be a low power and/or ultra-low power wakeup receiver. In some instances, wakeup radio circuitry may only be powered/active when cellular communication circuitry 430 and/or the short to medium range wireless communication circuitry 429 are in a sleep/no power/inactive state. In some instances, wakeup radio circuitry 431 may monitor (e.g., periodically) a specific frequency/channel for a wakeup signal. Receipt of the wakeup signal may trigger the wakeup radio circuitry 431 to notify (e.g., directly and/or indirectly) cellular communication circuitry 430 to enter a powered/active state.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”).

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for methods for sidelink control and synchronization reference signaling for SL PRS transmission, e.g., in 5G NR systems and beyond, as further described herein. For example, the communication device 106 may be configured to perform methods for CORESET #0 configuration, SSB/CORESET #0 multiplexing pattern 1 for mixed SCS, time-domain ROs determination for 480 kHz/960 kHz SCSs, and RA-RNTI determination for 480 kHz/960 kHz SCSs.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

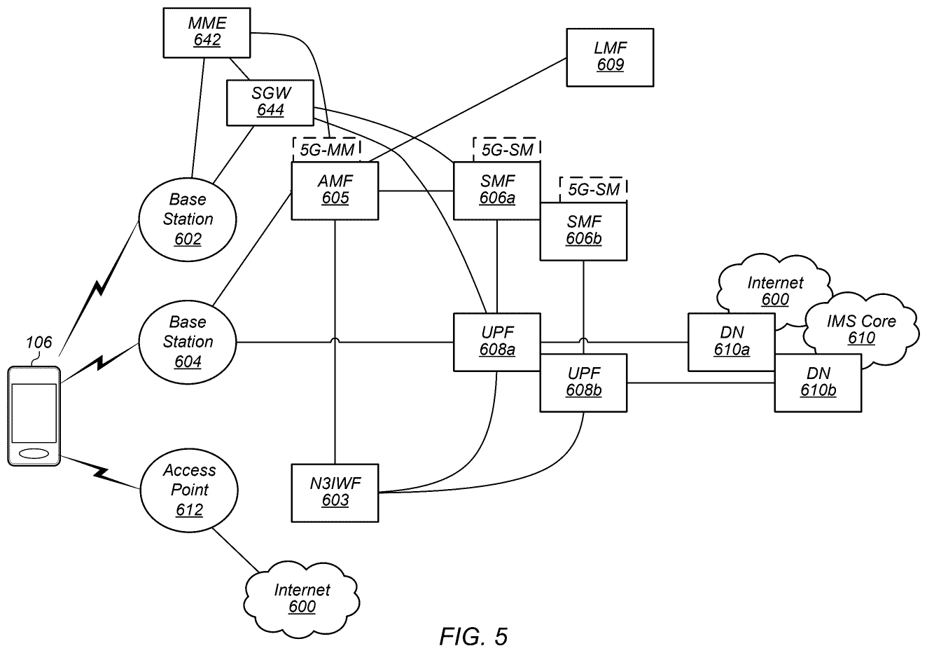

### FIG. 5: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 5 illustrates an example of a 5G network architecture that incorporates both dual 3GPP (e.g., cellular access via LTE and 5G-NR) and non-3GPP (e.g., non-cellular) access to the 5G CN, according to some embodiments. As shown, a user equipment device (e.g., such as UE 106) may access the 5G CN through both a radio access network (RAN, e.g., such as gNB 604 or eNB 602, each of which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include functional entities associated with the 5G CN (e.g., such as a network slice selection function (NSSF), a short message service function 622, an application function (AF), unified data management (UDM), a policy control function (PCF), and/or an authentication server function. Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

Note that in various embodiments, one or more of the above-described entities may be configured to perform methods for sidelink operation enhancements, e.g., in 5G NR systems and beyond, e.g., as further described herein.

### Sidelink Operation Enhancements

In 3GPP Release 16, NR sidelink channel state information (CSI) is only for unicast transmissions. A CSI reference signal (RS) configuration is given by a PC5 radio resource control (RRC) configuration from a UE transmitting the CSI-RS and CSI acquisition can be enabled or disabled by the PC5-RRC configuration. Further, in 3GPP Release 16, CSI measurement on sidelink CSI-RS is based on CSI-RS confined in a physical sidelink shared channel (PSSCH) and there is no standalone CSI-RS transmission dedicated to CSI reporting. Additionally, there is no standalone interference measurement for CSI. In addition, sidelink control information (SCI) associated with the PSSCH containing the CSI-RS triggers CSI reporting. Regarding, CSI reference resources in 3GPP Release 16, time domain resources are determined based on the slot the CSI trigger is received and frequency domain resources are the physical resource blocks (PRBs) scheduled for the PSSCH in the CSI reference resource slot. Note than an NR CSI-RS sequence is defined as a baseline for a sidelink CSI-RS sequence with n_ID determined by a 10-bit least significant bit of a cyclical redundancy check (CRC) of the corresponding first SCI. Further, regarding CSI reporting in 3GPP Release 16, CSI reporting is aperiodic, contains only channel quality indicator (CQI) and rank indicator (RI) (either rank 1 or rank 2) and there is no pre-coding matric indicator (PMI). CSI reporting is carried on the PSSCH and higher layer signaling (e.g., medium access control (MAC) control element (CE)) is used for CQI/RI reporting. Note that sidelink CQI/RI measurement is based on existing physical layer procedure for Uu. Note further that for a reporting window, a transmitting UE cannot transmit multiple CSI triggers with overlapping CSI report window in a given unicast session and a latency bound of a CSI report is signaling from CSI triggering UE to CSI reporting UE via PC5-RRC. Finally, in 3GPP Release 16, a CQI table is derived based on an indicated modulation and coding scheme (MCS) table.

In 3GPP Release 18, a work item is ongoing to study enhanced sidelink operation on frequency range 2 (FR2) licensed spectrum. The focus is mainly on updating the evaluation methodology for commercial deployment scenario and is limited to the support of sidelink beam management (including initial beam-pairing, beam maintenance, beam failure recovery, and so forth) by reusing existing sidelink CSI framework (e.g., 3GPP Release 16) and reusing Uu beam management concepts wherever possible. Note that beam management in FR2 licensed spectrum considers sidelink unicast communication only.

At this time, agreement has been reached on various aspects of sidelink operation. For example, a procedure for initial beam pairing can be performed before a sidelink unicast link establishment and the procedure can include at least a first UE sending reference signals via different transmit beams (note that multiple reference signal transmissions (e.g., repetitions) from each of the beams can be considered), a second UE measuring the reference signals and determining a transmit beam for the first UE and/or a receive beam for the second UE, the second UE indicating to the first UE the determined transmit beam for the first UE, and the first UE and the second UE setting up a sidelink unicast link using the determined beams by following existing link establishment procedures. However, left undetermined was when reference signals are sent, what are the applicable reference signals, whether and/or how to determine a transmit beam for the second UE, and how to indicate the determined transmit beam, including its feasibility. As another example, a procedure for initial beam pairing can be performed during a sidelink unicast link establishment and the procedure can include at least a first UE sending a PSCCH/PSSCH that carries a unicast link establishment message (e.g., a DCR message) via different transmit beams (note that multiple PSCCH/PSSCH transmissions (e.g., repetitions) from each of the beams can be studied), when a second UE successfully decodes one (or more) of the PSCCH/PSSCH(s) and the second UE determines to establish a unicast link with the first UE, the second UE indicating to the first UE one (or more) transmit beam(s) of PSCCH/PSSCH(s) which were successfully received, and the first UE using one of the indicated beam(s) to finish the remaining sidelink unicast link establishment procedure with the second UE. However, left undetermined was what are applicable reference signals which can be transmitted together with a unicast link establishment message, whether the beam indication is implicit or explicit, how to map between each PSCCH/PSSCH and the first UE's transmit beam, how the second UE determines transmit beam(s) for the first UE and/or transmit/receive beam(s) for the second UE, how the first UE determines one of the indicated beam(s), and usage of additional reference signal or additional messages or additional measurement for efficient beam pairing.

Further, agreement has been reached to study the feasibility of adapting a sidelink synchronization signal block (S-SSB) for initial beam pairing between a first UE and a second UE as well as to study the feasibility of reusing a sidelink channel state information reference signal (SL CSI-RS) for initial beam pairing between a first UE and a second UE. Note that considerations for adapting an S-SSB for initial beam pairing include at least whether and/or how to enable a second UE to identify a first UE (e.g., source ID) from the first UE's S-SSB transmission, whether and/or how to enable the first UE to identify the corresponding beam measurement/reporting from the second UE, mapping between S-SSB transmission/resource and beam related information, allocation of beam reporting resources respectively associated with different S-SSB transmit beams, structure and contents of an S-SSB, triggering and/or activation of S-SSB transmission, if needed, mechanism for S-SSB monitoring and reporting/responding, mechanism to mitigate and/or avoid the interference between overlapped S-SSB transmissions from different UEs, including S-SSB transmission resources, and any potential impact to/from other UEs and whether and/or how to avoid and/or mitigate this impact. Note additionally that considerations for reusing an SL CSI-RS for initial beam pairing include at least whether an SL CSI-RS transmission will be with or without sidelink data transmission in the same slot, including slot structure, mapping between SL CSI-RS transmission/resource and beam related information, whether the SL CSI-RS transmission will be a periodic SL CSI-RS transmission, a semi-persistent SL CSI-RS transmission, or an aperiodic SL CSI-RS transmission, with or without SCI indication, allocation of SL CSI-RS beam sweeping resources and if applicable, their associated beam reporting resources, possibility of applying SL CSI-RS for initial beam pairing before, during, or after unicast link establishment, including how to provide SL CSI-RS resource configuration, whether and/or how to mitigate and/or avoid interference between overlapped SL CSI-RS transmissions from different UEs, and whether a SL CSI-RS transmission will be with or without repetition on transmit beams.

In addition, agreement has been reached to study sidelink beam failure recovery (BFR) mechanisms at least for the scheme where a sidelink beam failure indicator (BFI) is triggered based on a measurement of a reference signal for BFD (if supported) including candidate beam identification, sidelink BFR request (BFRQ), including resources, transmit and/or receive beams, container, timing, and so forth, sidelink BFR response (BFRR), including container, procedure, timing, and so forth. However, left for further study are details regarding reference signals for candidate beam identification, including structure, procedure, and timing as well as applicability to the scheme where SL BFI is triggered based on SL HARQ feedback (if supported).

Therefore, improvements are desired.

Embodiments described herein provide systems, methods, and mechanisms for sidelink operation enhancements, including systems, methods, mechanisms for initial beam pairing before a sidelink unicast link establishment, initial beam pairing during sidelink unicast link establishment, usage of SL CSI-RS and/or S-SSB for initial beam pairing, and triggering of BFR reference signal transmission. In particular, embodiments described herein provide a design for initial beam pairing performed before sidelink unicast link establishment, including reference signal design for initial beam pairing, establishing when the reference signal for initial beam pairing is sent, mechanisms for determining how a receiving UE determines a transmitting UE's transmit beam, and mechanisms for determining how a receiving UE indicates the determined transmit beam to the transmitting UE. In addition, embodiments described herein provide a design for initial beam pairing performed during sidelink unicast link establishment, including defining what reference signal is transmitted together with unicast link establishment message, mechanisms for a receiving UE to determine a transmit beam of a transmitting UE, mechanisms for the receiving UE to determine its transmit/receive beam, mechanisms for the transmitting UE to determine one of the indicated beam(s) based on the receiving UE's report, and mechanisms for using additional reference signal or additional messages or additional measurements for efficient beam pairing. Further, embodiments described herein provide mechanisms for reusing SL CSI-RS/S-SSB for initial beam pairing, including mechanisms for allocating SL CSI-RS beam sweeping resources and mechanisms for determining an association between SL CSI-RS/S-SSB beam sweeping resources and their associated beam reporting resources. Additionally, embodiments described herein provide mechanisms for triggering BFR reference signal transmission.

For example, in some instances, for initial beam pairing before a sidelink unicast link set up, a triggering condition for reference signal transmissions may be defined as just before a transmitting UE, such as UE 106, wants to initiate a sidelink unicast link set up or may be defined to be periodic (e.g., always transmitted, but with a large periodicity). In the case of the triggering condition for reference signal transmissions is defined as just before a transmitting UE wants to initiate a sidelink unicast link set up, the transmitting UE may transmit reference signals within a widow of n-A1 and n-A2, where n is a slot that the transmitting UE wants to initiate the sidelink unicast link set up and A1 and A2 are constants that may be determined based on one or more of (and/or any combination of) a resource pool (pre)configuration, a service type of the sidelink unicast link, the transmitting UE's implementation, a channel busy ration (CBR) for a resource pool, and/or a CBR of dedicated reference signal resources. Further, in some instances, a reference signal may be an S-SSB or an SL CSI-RS.

To avoid unnecessary reference signal transmissions and to mitigate the resource congestion, a transmitting UE may not need to periodically transmit reference signals (e.g., S-SSB or sidelink CSI-RS) for initial beam pairing if the transmitting UE does not want to trigger sidelink unicast establishment and/or if the transmitting UE has already paired beams for a sidelink unicast link. Specifically, the transmitting UE may start sending reference signals within a window duration before triggering sidelink unicast link establishment and may stop sending reference signals after initial beam pair is obtained.

In some instances, when a reference signal for beam management is an S-SSB for beam management, the S-SSB for beam management may be distinct from a 3GPP Release 16 S-SSB (R16 S-SSB) for synchronization. Thus, slots of the S-SSB for beam management may or may not belong to a resource pool and a relationship between slots of the S-SSB for beam management and slots of R16 S-SSB may be (pre)configured. A periodicity of the S-SSB for beam management may be the same as a periodicity of R16 S-SSB. In some instances, S-SSB for beam management resources may be one per slot. In such instances, all UEs may share the same S-SSB resource in a slot. Hence, any UE may use the S-SSB for beam management resource without any resource selection. In some instances, a UE may use an S-SSB for beam management resource in a slot based on the UE's source ID or service ID. In such instances, a mapping between a UE's source ID or service ID to the S-SSB slot or resource may be (pre)configured. In other instances, S-SSB for beam management resources may be more than 1 per slot. In such instances, the S-SSB resources for beam management may be frequency division multiplexed and/or time division multiplexed in a slot. In the case of time division multiplexing, each S-SSB for beam management transmission may be a sub-slot operation.

In some instances, when a reference signal for beam management is an SL CSI-RS, SL CSI-RS resources for initial beam pairing may occupy dedicated slots which may not be used for legacy sidelink data transmissions. Note that such SL CSI-RS transmissions are standalone transmissions. In some instances, the SL CSI-RS resources for initial beam pairing may be shared among UEs and multiple SL CSI-RS resources may be time division multiplexed and/or frequency division multiplexed in a slot. In some instances, slots of SL CSI-RS for beam management may or may not belong to a resource pool. In some instances, a UE's resource selection of SL CSI-RS for beam management may follow legacy resource selection procedures for sidelink data transmissions and PSCCH and/or PSSCH (with SCI stage 2 or MAC CE) may be transmitted with SL CSI-RS, which reserves the SL CSI-RS resources. In such instances, a source ID and/or destination ID may be carried in PSCCH and/or PSSCH. Further, PSCCH/PSSCH for sidelink data transmission may reserve resources for the SL CSI-RS transmission. In other instances, a UE's resource selection of SL CSI-RS for beam management may be based on a mapping between a UE's source ID/service ID to particular SL CSI-RS resources.

In some instance, a receiving UE may determine its transmit beam towards a transmitting UE so that the receiving UE can indicate its determined transmit beam to the transmitting UE. In some instances, beam correspondence may be assumed where the receiving UE's transmit beam towards the transmitting UE is equal to or derived from the receiving UE's receive beam from the transmitting UE. In other instances, the receiving UE may use a wide beam to indicate its determined transmit beam for a transmitting UE. This wide beam may cover the receiving UE's receive beam from the transmitting UE. This wide beam may be omni-directional.

In some instance, a receiving UE may indicate, to a transmitting UE, the transmit beam of the transmitting UE determined by the receiving UE. In some instances, the receiving UE may send a PSCCH/PSSCH using legacy sidelink date transmission resources. The contents of the PSCCH/PSSCH may include a transmitting UE's ID and a receiving UE's ID, as well as the transmitting UE's transmit beam corresponding to the transmitting UEs' reference signal transmission. In other instances, the receiving UE may use dedicated resources corresponding to its determined transmitting UE's transmit beam (or reference signal transmission resources). The contents of this transmission may include a transmitting UE's ID and a receiving UE's ID. The container of this transmission may be a PSFCH or SCI.

Note that in NR Uu link, each SSB transmission with a transmit beam has an associated random access channel (RACH) occasion. After determining an SSB transmit beam, a UE selects the associated RACH occasion for its PRACH transmission. Depending on which RACH occasion of receiving PRACH from a UE, a base station is able to obtain the transmit beam to serve the UE. A similar SSB-RACH association mechanism could be applied to sidelink. For example, each S-SSB or sidelink CSI-RS transmit beam may have an associated beam reporting occasion (e.g., similar to RACH occasion in NR Uu link). After determining a transmitting UE's transmit beam, a receiving UE may use the associated beam reporting occasion to indicate the transmitting UE's transmit beam. However, unlike NR Uu link, RACH procedures do not exist in sidelink. Further, a contention resolution mechanism may not be necessary for sidelink since a UE is allowed to use a resource pool for sidelink transmissions without the admission from another UE.

In some instances, if reference signals sent by a transmitting UE are via sidelink broadcast (e.g., S-SSB), then multiple UEs may measure the reference signal and indicate to the transmitting UE their determined transmitting UE's transmit beam(s). The beam reporting from multiple UEs is likely transmitted on different beam reporting occasions, each corresponding to a separate reference signal transmit beam. Additionally, ff two UEs send beam reporting on different beam reporting occasions, it is unclear how the transmitting UE determines the transmit beam to be used for a target receiving UE. In such instances, the transmitting UE's ID and the receiving UE's ID may be included in the beam reporting. A receiving UE may randomly select a beam reporting resource among the set of resources associated with transmitting UE's reference signal via a certain beam. Note that if the reference signals sent by transmitting UE are via sidelink unicast (e.g., sidelink CSI-RS), then the situation that multiple UEs measure the reference signal and indicate the determined transmitting UE's transmit beam can be avoided.

As another example, in some instances, for initial beam pairing during a unicast link set up, a reference signal transmitted together with unicast link establishment message may be a non-standalone sidelink CSI-RS. The non-standalone sidelink CSI-RS may have the same beam direction as a PSCCH/PSSCH transmission that carries a unicast link establishment message. In addition, the non-standalone sidelink CSI-RS beam ID may be indicated by SCI of the PSCCH/PSSCH transmission. Note that such a scheme may address a mapping of each message and a transmitting UE's transmit beam. A reference signal transmitted together with unicast link establishment message may be PSCCH DMRS or PSSCH DMRS.

In some instances, a receiving UE may determine a transmitting UE's transmit beam by decoding a message carried by the transmitting UE's transmit beam and the receiving UE has a largest reference signal received power (RSRP) among all beam directions whose carrying message is decoded successfully. In other words, when a receiving UE decodes a message carried by a transmitting UE's transmit beam and the message is associated with the largest RSRP among beam directions whose carrying message the receiving UE decoded. Alternatively, in some instances, a receiving UE may randomly select a transmitting UE's transmit beam among all of the transmitting UE's transmit beams whose corresponding message have been received successfully. As another alternative, a receiving UE may determine all of a transmitting UE's transmit beams whose corresponding message have been received successfully. In some instance, to determine a receiving UE's transmit beam towards a transmitter UE, the receiving UE may assume beam correspondence where the receiving UE's transmit beam to a transmitting UE is equal to the receiving UE's receive beam from the transmitting UE. Alternatively, a receiving UE may use a wider transmit beam and the wide transmit beam may cover the receiving UE's receive beam from the transmitting UE. In some instances, the wide transmit beam may be an omni-directional beam. In addition, in some instances, the transmitting UE may determine an indicated beam from the receiving UE as a first indicated beam from the receiving UE or based on implementation at the transmitting UE.

In some instances, for each PSCCH/PSSCH transmission which is successfully received by a receiving UE, the receiving UE may measure an accompanying reference signal and may report an RSRP measurement to a transmitting UE. A mapping between each PSCCH/PSSCH transmission and its corresponding RSRP measurement reporting may follow existing PSSCH-PSFCH mapping rules. In some instances, among a list of RSRP measurement reporting, the receiving UE may determine the transmitting UE's transmit beam and the receiving UE's receive beam e.g., beams which have a largest RSRP measurement. Similarly, the transmitting UE may determine its transmit beam, e.g., a beam that may have a largest RSRP measurement report.

For example, a transmitting UE may transmit a PSCCH/PSSCH together with reference signals via three different transmit beams. A receiving UE may successfully decode the first two PSCCH/PSSCH transmissions. The receiving UE may also measure RSRP of the reference signals transmitted together with these two PSCCH/PSSCH transmissions. These two RSRP measurements may be reported respectively to the transmitting UE, based on a mapping rule between PSCCH/PSSCH and beam reporting. Finally, the receiving UE may determine the transmitting UE's transmit beam and the receiving UE's receive beam, e.g., may determine which beams have the largest RSRP measurement.

In some instances, for efficient beam pairing, the transmitting UE may transmit additional S-SSB transmissions. In some instances, each of the transmitting UE's PSCCH/PSSCH carrying unicast link establishment messages may use the same beams as an S-SSB transmission. Note that there may be no need for an SL CSI-RS transmission together with PSCCH/PSSCH carrying unicast link establishment messages because an SCI in the PSCCH/PSSCH may indicate the S-SSB beam index and, if the receiving UE decodes one or more PSCCH/PSSCH carrying unicast link establishment, the receiving UE may check the corresponding S-SSB measurement results and indicate the S-SSB beam index to the transmitting UE.

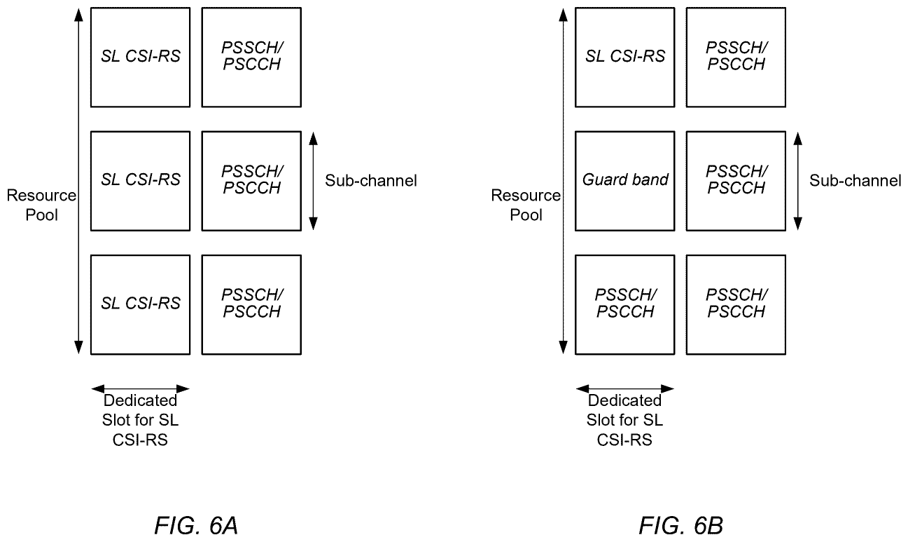

In some instances, allocation of resources for reference signals for beam sweeping may include dedicated slots for SL CSI-RS transmissions for beam sweeping. In some instances, standalone SL CSI-RS transmissions may be sent with an SCI stage 1 in PSCCH to indicate one or more of resource reservation information and/or SL CSI-RS related information. The SL CSI-RS related information may include an indication of which resources (e.g., symbols) in a slot are used for SL CSI-RS transmission and their respective associated beam ID. Note that it may be possible that all the SL CSI-RS resources are associated with the same beam ID (e.g., repetition on transmit beams). Note further that such information may also be carried in a SCI stage 2 or SL MAC CE. In some instances, standalone SL CSI-RS transmissions may be sent with an SCI stage 2 in PSSCH to indicate source ID and/or destination ID information. The SCI stage 2 format may include full 24-bit source ID and destination ID. In some instances, the dedicated slots used for the standalone SL CSI-RS transmissions may not be used for sidelink data transmissions. Note that there may be multiple SL CSI-RS transmissions, as well. Further, regarding frequency domain design of the dedicated resources, in some instances, the SL CSI-RS transmissions may occupy all of a resource pool and/or a portion of the resource pool. For example, FIG. 6A illustrates an example of SL CSI-RS transmissions occupying all of a resource pool. Note that when the SL CSI-RS transmissions occupy a portion of the resource pool, the remaining or other portion of the resource pool may be used for PSCCH/PSSCH and/or PSFCH transmissions so long as there is enough frequency gap between the two portions. For example, FIG. 6B illustrates an example of an SL CSI-RS transmission occupying a portion of a resource pool and another portion of the resource pool being occupied by PSCCH/PSSCH. As shown, the SL CSI-RS and PSCCH/PSSCH may be separated by a guard band. In some instances, each SL CSI-RS transmission may be in one sub-channel. In such instances, the SL CSI-RS transmission may be in a sub-channel as defined for legacy PSCCH/PSSCH. In other such instances, the SL CSI-RS transmission may be in a smaller sub-channel than as defined for legacy PSCCH/PSSCH.

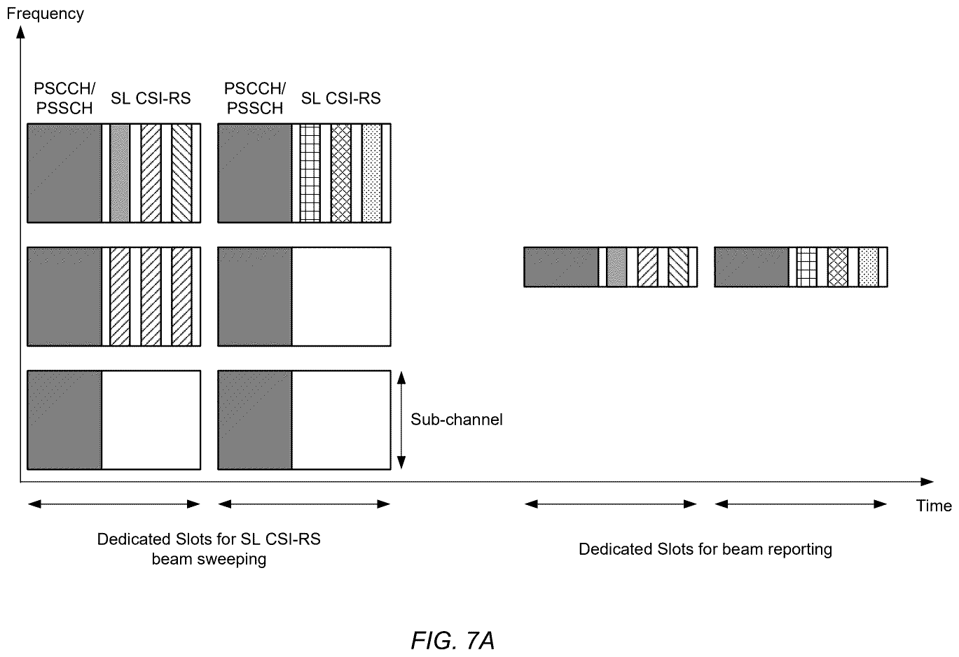

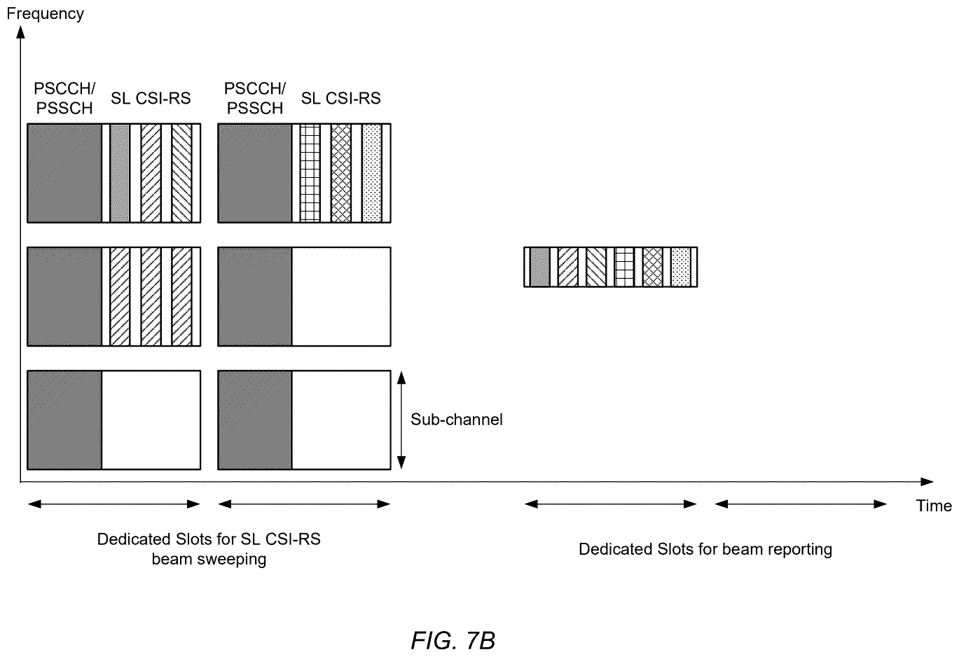

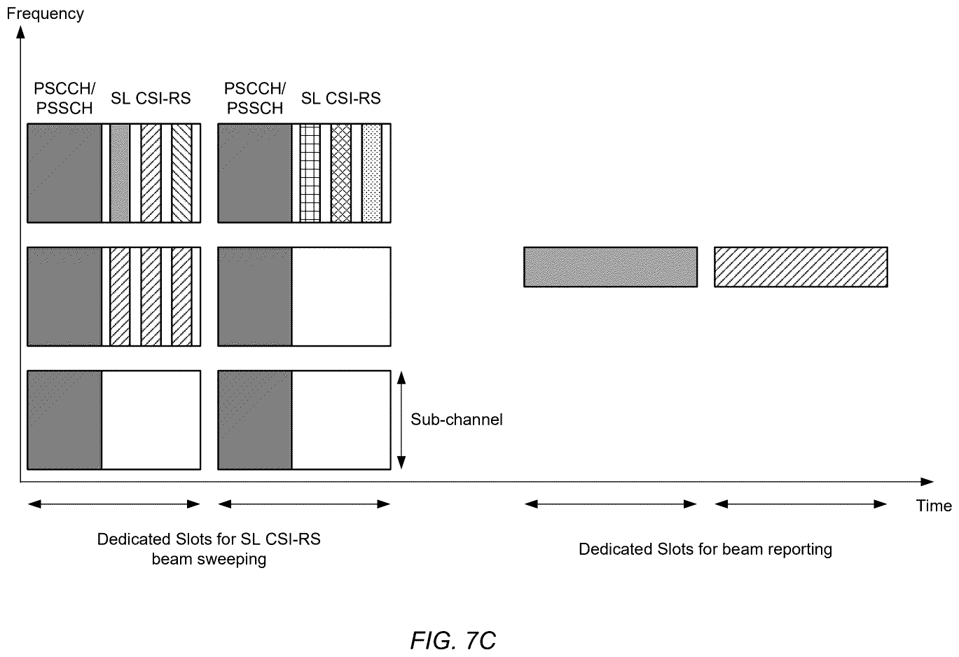

In some instances, allocation of resources for beam reporting may include dedicated slots for beam reporting. The dedicated slots for beam reporting may be used for SL CSI-RS and S-SSB. In some instances, a connection between dedicated slots for SL CSI-RS transmission and dedicated slots for beam reporting may be pre-defined or (pre-) configured. For example, in some instances, dedicated slots for beam reporting may be pre-defined as a specified number of slots (e.g., such as two, three, or four slots) after for SL CSI-RS transmissions. As another example, in some instances, dedicated slots for beam reporting may be (pre-) configured based on a gap between dedicated slots for SL CSI-RS transmissions and dedicated slots for beam reporting. In some instances, one dedicated slot for SL CSI-RS transmission may be linked to one dedicated slot for beam reporting, e.g., as illustrated by FIG. 7A. In other instances, multiple dedicated slots for SL CSI-RS transmission may be linked to one dedicated slot for beam reporting, e.g., as illustrated by FIG. 7B. In yet other instances, one dedicated slot for SL CSI-RS transmission may be linked to multiple dedicated slots for beam reporting, e.g., as illustrated by FIG. 7C. In some instances, a slot structure may be defined as multiple dedicated symbols corresponding to multiple SL CSI-RS transmissions. In such instances, a mapping between a dedicated symbol and a SL CSI-RS transmission in a slot may be pre-defined or (pre-)configured. Note that automatic gain control (AGC) may be applied to each dedicated symbol. Note further that a source ID and destination ID may be carried by SCI stage 1, SCI stage 2 and/or MAC CE, which may be transmitted together with the dedicated symbols. In some instances, beam reporting resources may occupy all of a resource pool and/or a portion of the resource pool. Note that when the beam report occupies a portion of the resource pool, the remaining or other portion of the resource pool may be used for PSCCH/PSSCH and/or PSFCH transmissions so long as there is enough frequency gap between the two portions. In some instances, each beam report may be in one physical resource block (PRB) or in one sub-channel. Note that the sub-channel may be as defined for legacy PSCCH/PSSCH and/or as defined for SL CSI-RS transmission.

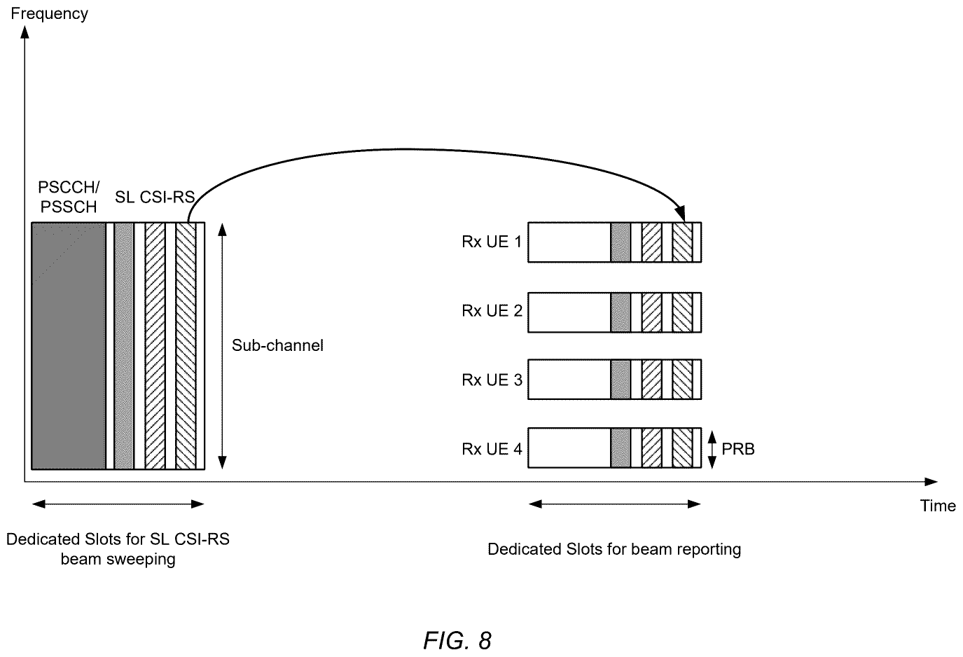

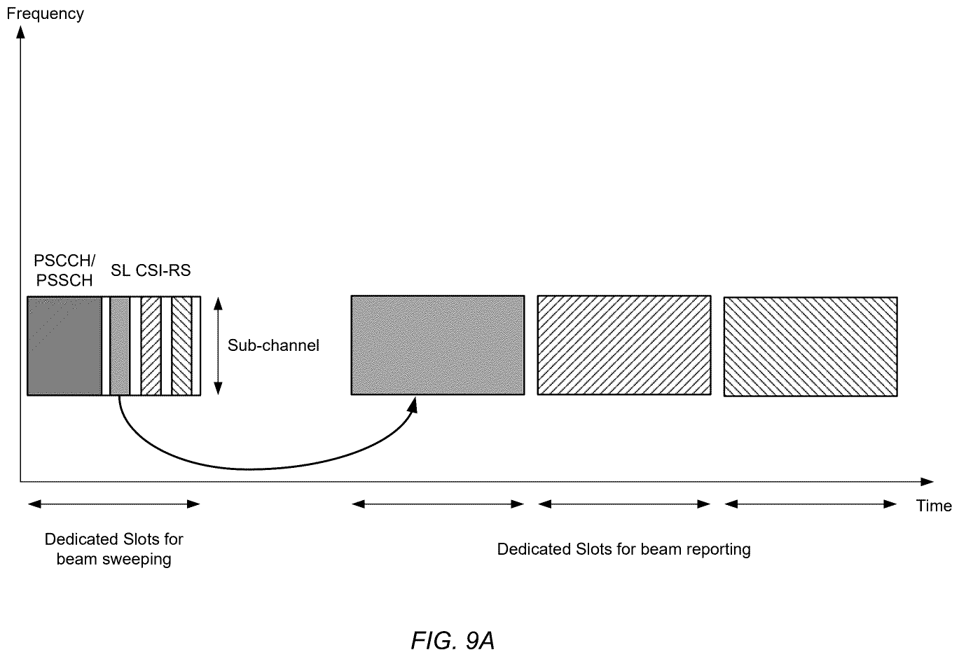

In some instances, when using dedicated slots for beam reporting, a receiving UE may use PSFCH based beam reporting. In such instances, the receiving UE may send one PSFCH transmission on a resource associated with a selected SL CSI-RS transmission/resource. In some such instances. one PRB of a PSFCH resource may be associated with one SL CSI-RS transmission (e.g., no multiplexing). Further, a (pre-) configured and/or (pre-) defined cyclic shift value may be applied for PSFCH sequence generation and may be suitable when an initial beam pairing is during or after a unicast link establishment. The cyclic shift value for PSFCH sequence generation may depend on a transmitting UE's ID and/or receiving UE's ID (e.g., code domain multiplexing) and may be suitable when an initial beam pairing is before unicast link establishment and/or when all the receiving UE's transmissions occupy the same PRB. In other such instances, multiple PRBs of PSFCH resources may be associated with one SL CSI-RS transmission (e.g., frequency domain multiplexing), for example, as illustrated by FIG. 8. As shown, each receiving UE may select a corresponding PRB among multiple PRBs of PSFCH resources which are associated with one SL CSI-RS transmission, depending on the transmitting UE's ID and/or receiving UE's ID or may be randomly selected.

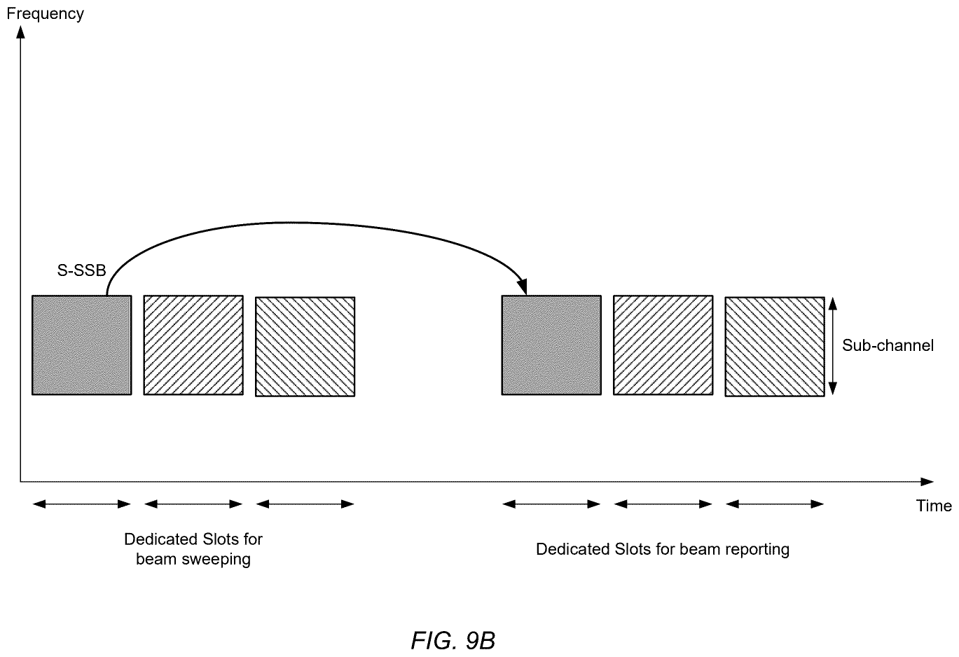

In other instances, when using dedicated slots for beam reporting, a receiving UE may use PSCCH/PSSCH based beam reporting. In some instances, there may be one PSCCH/PSSCH transmission on a resource associated with a selected SL CSI-RS transmission/resource. Further, consecutive slots or non-consecutive slots are possible. FIG. 9A illustrates an example of a receiving UE using PSCCH/PSSCH based beam reporting for SL CSI-RS based beam sweeping and FIG. 9B illustrates an example of a receiving UE using PSCCH/PSSCH based beam reporting for S-SSB based beam sweeping.

In some instances, if an initial beam pairing is performed before sidelink unicast link establishment, a transmitting UE generally does not have any sidelink data to send to a receiving UE at the stage of initial beam pairing. Thus, in such instances, a sidelink CSI-RS may be transmitted without sidelink data transmission in the same slot. A transmitting UE may not need to continue transmitting sidelink CSI-RS for initial beam pairing, as doing so may lead to network congestion. A transmitting UE may only need to send a sidelink CSI-RS before it wants to establish the sidelink unicast link. Hence, a semi-persistent sidelink CSI-RS transmission may be suitable for beam sweeping. In some instances, a list of resources of sidelink CSI-RS beam sweeping may be (pre-) configured, e.g., in certain slots. Each transmitting UE may perform a resource selection scheme to allocate sidelink CSI-RS resources for its beam sweeping. Similar to S-SSB, each sidelink CSI-RS transmission resource may have an associated beam reporting resource via (pre-) configuration. Further, when a receiving UE sends a beam reporting associated with the transmitting UE's sidelink CSI-RS transmit beam, the receiving UE may indicate the corresponding transmitting UE's sidelink CSI-RS transmit beam.

In some instances, if an initial beam pairing is performed during sidelink unicast link establishment, a transmitting UE may send a sidelink CSI-RS together with PSCCH/PSSCH that carries unicast link establishment messages (e.g., a direct communication request (DCR) message). Furthermore, such a sidelink CSI-RS transmission may be aperiodic. There may be no need for a separate resource allocation for sidelink CSI-RS transmissions and overlapped sidelink CSI-RS transmissions from different UEs may be avoided by PSSCH resource allocation. The beam reporting resources associated with sidelink CSI-RS transmit beams may follow a mapping rule similar to a PSSCH-PSFCH mapping rule.

In some instances, if an initial beam pairing starts after sidelink unicast link establishment, both transmitting UE and receiving UE may use a PC5-RRC message to configure sidelink CSI-RS beam sweeping resources. Additionally, the transmitting UE may perform a resource selection scheme to allocate sidelink CSI-RS resources for its beam sweeping. The sidelink CSI-RS may be transmitted with or without sidelink data transmission in the same slot. In addition, the beam related information for the sidelink CSI-RS may be indicated by SCI transmitted together with sidelink CSI-RS. The beam reporting may be carried in PSSCH, whose transmission resources may be obtained via the legacy resource selection scheme.

In some instances, if a transmitting UE uses an S-SSB as a reference signal for initial beam pairing, a source ID of the transmitting UE may be included in the S-SSB, e.g., because an S-SSB may be sent from different UEs and without a source ID in the S-SSB, a receiving UE may be unable to distinguish which UE sent the S-SSB and may be unable to map beam measurement results to a particular UE.

Note that in a Uu link, a beam ID may be associated with an SSB index and up to 64 SSB indices are supported for FR2, which implies an SSB index can be indicated by 6 bits. The 3 most significant bits (MSB) of the SSB index may be carried as payload of a physical broadcast channel (PBCH) while the 3 lease significant bits (LSB) of the SSB index may be used to generate PBCH demodulation reference signal (DMRS). Such a mechanism may also be applied to S-SSB. In some instances, beam related information may be indicated by an S-SSB index, where the S-SSB index may be carried by a physical sidelink broadcast channel (PSBCH) payload and/or PSBCH DMRS sequence.

In some instances, if an S-SSB is to be used as a reference signal for initial beam pairing, the source ID may be included in the S-SSB, which implies the S-SSB may be sent by different UEs having different contents. Thus, if the resources for S-SSB for initial beam pairing are shared by multiple UEs, then there may be interference between overlapped S-SSB transmissions from different UEs. Thus, to mitigate or avoid the interference, different UEs may use different S-SSB resources. For example, a source ID of transmitting UE may be used to determine a corresponding S-SSB resource.

Note that in NR Uu link, each SSB transmission with a unique transmit beam has an associated random access channel (RACH) occasion. After determining an SSB transmit beam, a UE selects the associated RACH occasion for its PRACH transmission. Depending on the RACH occasion to receive PRACH from a UE, a base station is able to obtain the transmit beam to serve the UE. The PRACH transmission in NR Uu link can be considered as a way of beam reporting. In some instances, a similar SSB-RACH association mechanism may be applied to sidelink. For example, each S-SSB transmission/resource may have its associated beam reporting resource (similar to RACH occasion in Uu link). The association between S-SSB resource (or transmit beam) and beam reporting resource may be (pre-) configured.

In some instances, multiple neighbor UEs may receive a transmitting UE's S-SSB transmissions. However, before sidelink unicast link establishment, a neighbor UE cannot distinguish whether it needs to perform the measurement of the S-SSB transmissions due to the broadcast nature of S-SSB. Thus, it is possible that all neighbor UEs of the transmitting UE may send beam reporting to the transmitting UE. This may cause collisions to occur on the beam reporting resources if two or more UEs indicate the same S-SSB transmit beam. Additionally, multiple beam reporting from different UEs indicate different S-SSB transmit beams, leading to confusion at the transmitting UE side. It is preferred that the beam reporting is from a single target receiving UE, rather than from all neighbor UEs of the transmitting UE. Thus, in some instances, a destination ID of the S-SSB transmission may be indicated in the S-SSB, e.g., to avoid other UEs performing beam measurement and beam reporting. Note that according to layer-2 link establishment procedures, a direct communication request message may be broadcast or unicast, which implies that at least for the unicast DCR case, the destination ID (e.g., ID of a target UE (for unicast link establishment)) is known to transmitting UE beforehand. Hence, the transmitting UE may include the destination ID in S-SSB.

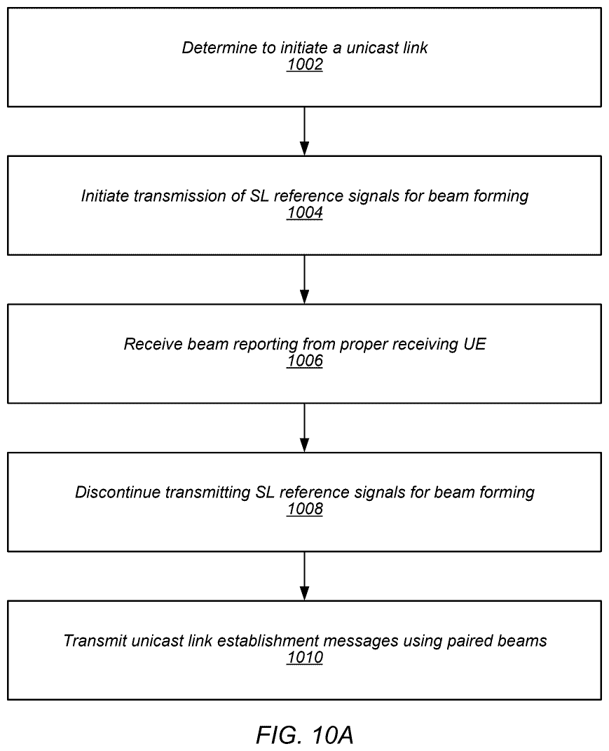

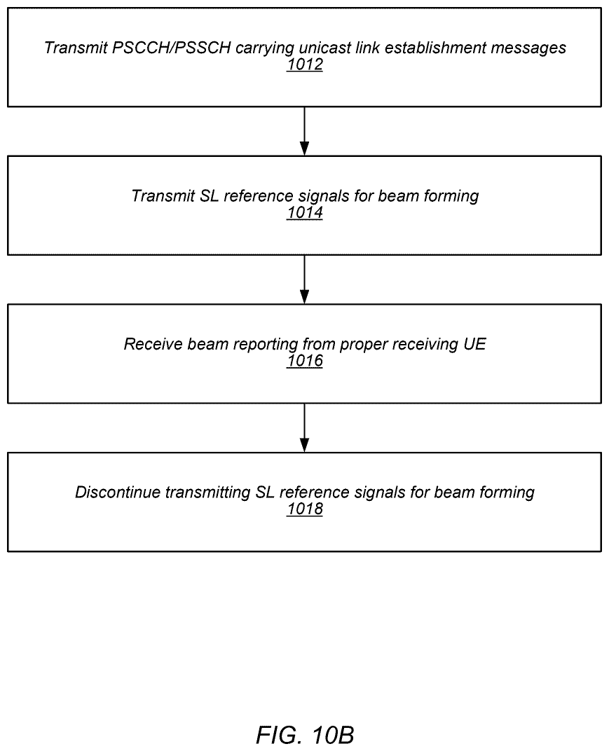

As another example, FIG. 10A illustrates a block diagram of an example of a method for triggering and de-activation of SL reference signal beam forming transmissions for initial beam pairing when beam pairing is before unicast link establishment, according to some embodiments. The method shown in FIG. 10A may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1002, a UE, such as UE 106, may determine to initiate a unicast link. Thus, the UE may be considered a transmitting UE.

At 1004, the UE may trigger (e.g., start) transmission of one or more SL reference signals for beam forming. The SL reference signals for beam forming may be SL CSI-RSs or S-SSBs. The transmissions may be within a window defined by [n-t0, n-t1], where n is a slot to start to initiate the unicast link establishment. Note that a number of reference signals for beam forming transmitted in the window may be (pre-) configured and may depend on a configuration of the sidelink reference signal for beam forming periodicity. Note further that t0 and t1 may also be (pre-) configured.

At 1006, the UE may receive reporting regarding the beam forming from an other UE. Thus, the other UE may be considered a receiving UE and may also be a UE 106.

At 1008, the UE may discontinue transmission of the reference signals for beam forming, e.g., based on the reporting. In some instances, a slot in which the transmission is discontinued may be defined as m-t2, where m is a slot designated for sending a direct communication accept message.

At 1010, the UE may transmit unicast link establishment messages via paired beams to the other UE.

As a further example, FIG. 10B illustrates a block diagram of an example of a method for triggering and de-activation of SL reference signal beam forming transmissions for initial beam pairing when beam pairing is during unicast link establishment, according to some embodiments. The method shown in FIG. 10B may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1012, a UE, such as UE 106, may transmit PSCCH/PSSCH carrying unicast link establishment messages.

At 1014, the UE transmit of one or more SL reference signals for beam forming. The SL reference signals for beam forming may be SL CSI-RSs or S-SSBs. The transmissions may be on the same beams used PSCCH/PSSCH carrying the unicast link establishment messages.

At 1016, the UE may receive reporting regarding the beam forming from an other UE. Thus, the other UE may be considered a receiving UE and may also be a UE 106.

At 1018, the UE may discontinue transmission of the reference signals for beam forming, e.g., based on the reporting.

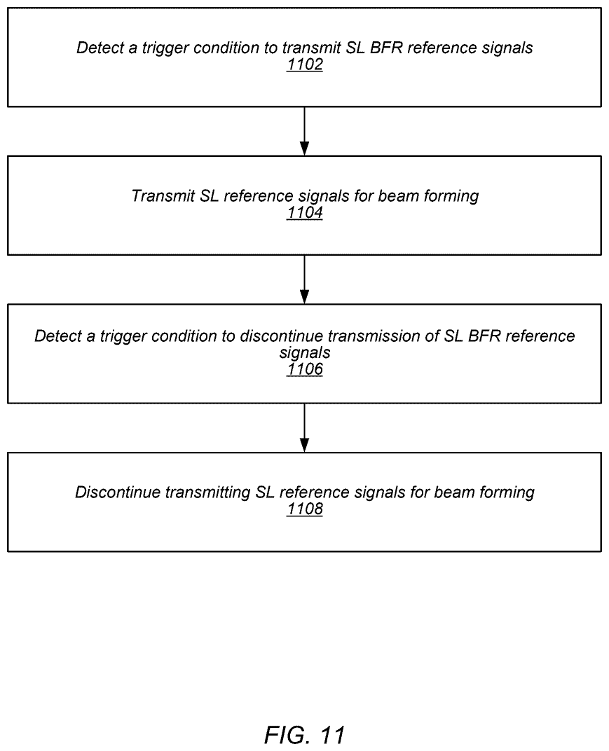

At yet another example, FIG. 11 illustrates a block diagram of an example of a method for triggering and de-activation of SL BFR (or BFD) reference signals, according to some embodiments. The method shown in FIG. 11 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1102, a UE, such as UE 106, may detect a triggering condition to transmit SL BFR reference signals. In some instances, the UE may detect a trigger condition when the UE does not receive HARQ feedback at HARQ occupations. For example, the trigger condition may be a consecutive number, N, of HARQ discontinuous reception cycles (DTX) larger than a threshold, Nthres. Note that threshold may be smaller than a threshold for SL radio link failure. Note further that the threshold may be (pre-) configured. In some instances, the UE may detect a trigger condition when the UE a BFR request from a receiving UE. The request may be indicated via MAC CE or SCI.

At 1104, the UE may transmit SL reference signals for beam forming. The SL reference signals for beam forming may be SL CSI-RSs or S-SSBs.

At 1106, The UE may detect a trigger condition to stop transmission of SL BFR reference signals. In some instances, the UE may detect a trigger condition when the UE receives a request from a receiving UE. In some instances, the UE may detect a trigger condition when the UE receives a BFR Response (BFRR) message from the receiving UE (e.g., which indicates the BFR has been performed). In some instances, the UE may detect a trigger condition when the UE receives M consecutive HARQ feedback from a receiving UE. Note that M may be (pre-) configured.

At 1108, the UE may discontinue (e.g., stop) transmission of SL reference signals for beam forming.

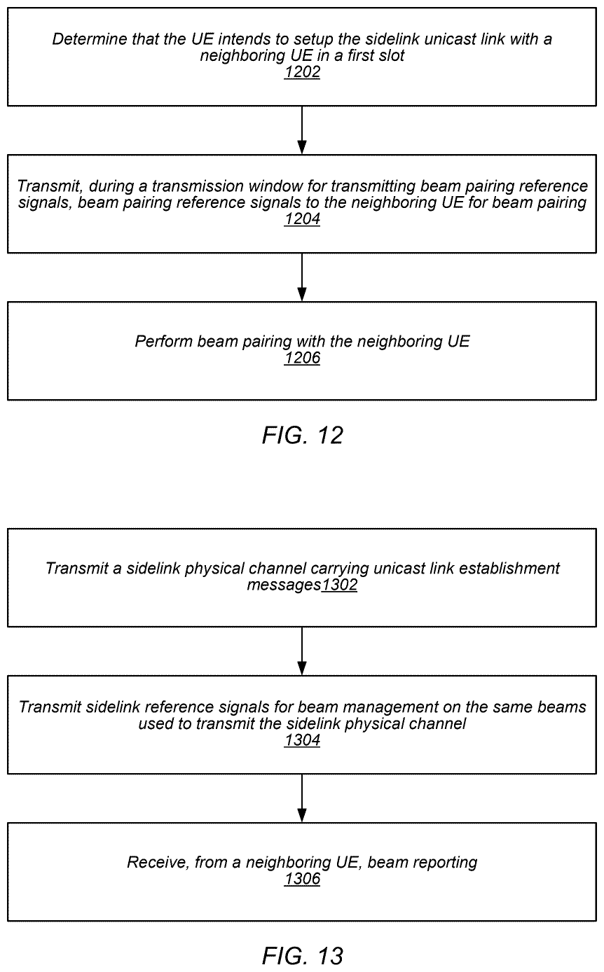

FIG. 12 illustrates a block diagram of an example of a method for initial beam pairing prior to set up of a sidelink unicast link, according to some embodiments. The method shown in FIG. 12 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1202, a UE, such as UE 106, may determine to set up a sidelink unicast link with a neighboring UE in a first slot. In some instances, the UE may determine that the UE intends to set up the sidelink unicast link with the neighboring UE in the first slot.

At 1204, the UE may transmit, during a transmission window for transmitting beam pairing reference signals, beam pairing reference signals to the neighboring UE for beam pairing. The transmission window may be defined based on the first slot. In some instances, the UE may determine the transmission window as [n-A1, n-A2]. In such instances, n may be a slot number associated with the first slot and A1 and A2 may be determined based, at least in part, on one or of a resource pool configuration, a resource pool pre-configuration, a service associated with the sidelink unicast link, the UE's implementation, channel busy ration (CBR) of the resource pool, and/or CBR of dedicated reference signal resources. In other instances, the transmission window may be defined based on a periodicity of transmission of beam pairing reference signals. In some instances, to avoid unnecessary reference signal transmissions and to mitigate resource congestion, the UE may not need to periodically transmit reference signals (e.g., S-SSB or sidelink CSI-RS) for initial beam pairing if the UE does not want to trigger sidelink unicast establishment and/or if the UE has already paired beams for a sidelink unicast link. Specifically, the UE may start sending reference signals within a window duration before triggering sidelink unicast link establishment and may stop sending reference signals after initial beam pair is obtained.

At 1206, the UE may perform beam pairing with the neighboring UE, e.g., based, at least in part, on the beam paring reference signals.

In some instances, the beam pairing reference signals may be sidelink synchronization signal blocks (S-SSBs) for beam management. In some instances, slots of S-SSBs for beam management may not be part of a resource pool associated with the UE. In other instances, slots of S-SSBs for beam management may be part of a resource pool associated with the UE. In some instances, a relationship between slots of S-SSBs for beam management and legacy S-SSBs for sidelink synchronization may be configured or pre-configured.

In some instances, a periodicity of slots of S-SSBs for beam management and legacy S-SSBs for sidelink synchronization may be the same. In such instances, S-SSB for beam management resources may include one resource per slot and the one resource per slot may be shared. In some instances, the one resource per slot may be used without resource selection. In some instances, access to the one resource per slot may be based on one of a source identifier (ID) or service (ID). In such instances, a mapping of one of the source ID or service ID to the one resource per slot may be configured or pre-configured.

In some instances, S-SSB for beam management resource may include a plurality of resources per slot. The plurality of resources per slot may be frequency division multiplexed within the slot, time division multiplexed within the slot, or multiplexed in the slot based on a combination of frequency division multiplexing and time division multiplexing. Further, for time division multiplexed resources within the slot, transmission of an S-SSB for beam management may include a sub-slot operation.

In some instances, the beam pairing reference signals may include sidelink channel state information reference signals (CSI-RSs) for beam management. In such instances, sidelink CSI-RSs for beam management resources may be configured or pre-configured per resource pool or per sidelink bandwidth part (BWP). In some instances, sidelink SL CSI-RS for beam management resources may occupy dedicated slots and the dedicated slots may not be used for legacy sidelink data transmissions. In some instances, sidelink SL CSI-RS transmissions for beam management may include standalone transmissions. In some instances, the sidelink CSI-RS for beam management resources may be shared resources. In such instances, multiple sidelink CSI-RS for beam management resources may be time division multiplexed or frequency division multiplexed within each dedicated slot. In some instances, the dedicated slots for sidelink CSI-RS for beam management may not belong to a resource pool. In other instances, the dedicated slots for sidelink CSI-RS for beam management may belong to a resource pool.

In some instances, resource selection of sidelink CSI-RS for beam management may be based on legacy resource selection procedures for sidelink data transmissions. In such instances, the UE may transmit a sidelink physical channel with one of a sidelink control information (SCI) stage 2 or medium access control (MAC) control element (CE) with a sidelink CSI-RS for beam management to reserves the resource for the sidelink CSI-RS for beam management. The sidelink physical channel may include one or more of a physical sidelink control channel (PSCCH) or a physical sidelink shared channel (PSSCH). Further, the sidelink physical channel may carry one or more of a source identifier or a destination identifier.

In some instances, resource selection of sidelink CSI-RS for beam management may be based on a mapping between one or more of a source identifier associated with the UE or service identifier associated with the UE to particular SL CSI-RS for beam management resources.

In some instances, beam correspondence may be assumed between the neighboring UE's transmit beam to the UE the neighboring UE's receive beam from the UE. In some instances, a transmit beam of the neighboring UE to the UE may be wider than a receive beam of the neighboring UE from the UE. In such instances, the transmit beam may cover the receive beam. Further, in such instances, the transmit beam may be an omni-directional beam.

In some instances, to perform beam pairing with the neighboring UE, the UE may receive, from the neighboring UE, a sidelink physical channel transmission indicating the neighboring UE's identifier (ID) and the UE's ID and a transmit beam of the UE corresponding to one of the UE's beam pairing reference signal transmissions. In such instances, the sidelink physical channel may be one or more of a physical sidelink control channel (PSCCH) or a physical sidelink shared channel (PSSCH).

In some instances, a transmit beam of the UE may use dedicated resources corresponding to one of the UE's beam pairing reference signal transmissions. In such instances, to perform beam pairing with the neighboring UE, the UE may receive, from the neighboring UE, a physical sidelink feedback channel transmission (PSFCH) or sidelink control information (SCI) indicating the neighboring UE's identifier (ID) and the UE's ID.

In some instances, beam pairing reference signals may be sidelink channel state information reference signals (SL CSI-RSs). In such instances, to transmit, during a transmission window for transmitting beam pairing reference signals, beam pairing reference signals to the neighboring UE for beam pairing, the UE may transmit SL CSI-RSs in dedicated slots. The SL CSI-RS transmissions may be sent with a sidelink control information (SCI) stage 1 and an SCI stage 2 in a physical sidelink control channel (PSCCH). In some instances, the SCI stage 1 may indicate resource reservation information and SL CSI-RS related information. The SL CSI-RS related information may include which resources or symbols in a slot are used for SL CSI-RS transmission and their respective associated beam identifier (ID). In such instances, all the SL CSI-RS resources may be associated with the one beam ID. In some instances, the SCI stage 2 may indicate source ID information and destination ID information. The SCI stage 2 may include a 24-bit source ID and a 24-bit destination ID. In some instances, the SCI stage 2 may further indicate SL CSI-RS related information. In such instances, the SL CSI-RS related information may include which resources or symbols in a slot are used for SL CSI-RS transmission and their respective associated beam ID. Further, all the SL CSI-RS resources are associated with the one beam ID.

In some instances, a sidelink medium access control (MAC) control element (CE) may indicate SL CSI-RS related information. In such instances, SL CSI-RS related information may include which resources or symbols in a slot are used for SL CSI-RS transmission and their respective associated beam ID. Further, all the SL CSI-RS resources may be associated with the one beam ID.

In some instances, SL CSI-RS resources may occupy an entire resource pool. In other instances, SL CSI-RS resources may occupy a first portion of a resource pool and a second portion of the resource pool may be used for a sidelink physical channel. Additionally, a frequency gap may separate the first portion and the second portion. The sidelink physical channel may be at least one of a PSCCH, a PSSCH, and/or a PSFCH.

In some instances, each SL CSI-RS transmission may be within a corresponding sub-channel. The sub-channel may be defined based on a definition of a legacy sub-channel of a PSCCH or a PSSCH or the sub-channel may be defined as smaller than the legacy sub-channel of a PSCCH or PSSCH.

In some instances, to perform beam pairing with the neighboring UE, the UE may receive, from the neighboring UE, beam reporting in dedicated slots. The dedicated slots may be associated with dedicated slots for transmission of the beam pairing reference signals. In some instances, the association may be pre-defined and a first dedicated slot for beam reporting may occur a pre-defined number of slots after a last dedicated slot for transmission of beam pairing reference signals. In some instances, the associated may be pre-configured and a first dedicated slot for beam reporting occurs a pre-configured gap after a last dedicated slot for transmission of beam pairing reference signals. In some instances, a dedicated slot for beam pairing reference signal transmission may be linked to a dedicated slot for beam reporting. In other instances, multiple dedicated slots for beam pairing reference signal transmissions maybe linked to a dedicated slot for beam reporting. In yet other instances, a dedicated slot for beam pairing reference signal transmission may be linked to multiple dedicated slots for beam reporting.

In some instances, a dedicated slot may include multiple dedicated symbols corresponding to multiple beam pairing reference signal transmissions. In such instances, a mapping between a dedicate symbol and a corresponding beam pairing reference signal transmission may be pre-defined or pre-configured. In addition, automatic gain control (AGC) may be applied to each dedicated symbol. In some instances, a source ID and a destination ID may be transmitted together with a dedicated symbol. In such instances, the source ID and the destination ID may be carried by at least one of a MAC CE, an SCI stage 1, or an SCI stage 2.

In some instances, dedicated slots for beam reporting may occupy a resource pool. In other instances, the dedicated slots for beam reporting may occupy a first portion of a resource pool and a second portion of the resource pool is used for sidelink physical channel transmissions. Additionally, a frequency gap may separate the first portion from the second portion. The sidelink physical channel may be at least one of a PSCCH, a PSSCH, and/or a PSFCH.

In some instances, beam reporting may occur in a physical resource block or in a sub-channel. The sub-channel may be defined based on a definition of a legacy sub-channel of a PSCCH or a PSSCH or the sub-channel is defined as a sub-channel used for beam pairing reference signal transmission.

In some instances, the beam reporting may be PSFCH based and the PSFCH may be carried on a resource associated with a selected beam pairing reference signal resource. In some instances, one physical resource block (PRB) of a PSFCH resource may be associated with one resource of a selected beam pairing reference signal. Additionally, a cyclic shift value may be applied for PSFSCH sequence generation. The cyclic shift value for PSFCH sequence generation may depend, at least in part, on one or more of an ID of the UE or an ID of the neighboring UE. In other instances, multiple PRBs of a PSFCH resource may be associated with one resource of a selected beam pairing reference signal. In such instances, a first PRB among the multiple PRBs may correspond to the neighboring UE and the correspondence may depend, at least in part, on one or more of an ID of the UE or an ID of the neighboring UE.

In some instances, the beam reporting may be PSCCH or PSSCH based and the PSCCH/PSSCH may be carried on a resource associated with a selected beam pairing reference signal resource.

In some instances, to transmit, during a transmission window for transmitting beam pairing reference signals, beam pairing reference signals to the neighboring UE for beam pairing, the UE may transmit, during the transmission window for transmitting beam pairing reference signals, a specified number of beam pairing reference signals to the neighboring UE for beam pairing. The specified number may be pre-configured and may depend, at least in part, on a configuration of a beam pairing reference signal periodicity.

In some instances, upon establishment of the sidelink unicast link with the neighboring UE. the UE may discontinue beam pairing reference signal transmissions a specified number of slots prior to the UE transmitting a direct communication accept message to the neighboring UE.

In some instances, the UE may detect, after establishing the sidelink unicast link with the neighboring UE, a triggering condition for transmitting beam failure recovery (BFR) reference signals. Further, in response to the detecting, the UE may transmit BFR reference signals and discontinue the transmitting when at least one recovery condition is satisfied. In some instances, the at least one recovery condition may include the UE receiving a BFR request (BFRQ) from the neighboring UE, the UE receiving a BFR response (BFRR) message from the neighboring UE indicating BFR has been performed, and/or the UE receiving a specified number of consecutive hybrid automatic repeat request (HARQ) feedbacks from the neighboring UE. The specified number may be pre-configured. In some instances, the trigger condition may include at least one of the UE failing to receive HARQ feedback from the neighboring UE in a specified number of consecutive HARQ feedback windows and/or the UE receiving a sidelink BFR request (BFRQ) from the neighboring UE. The specified number may smaller than a threshold for sidelink radio link failure. Additionally, the specified number may pre-configured. In some instances, a BFR reference signal may be a S-SSB for beam management and/or a SL CSI-RS for beam management.

FIG. 13 illustrates a block diagram of an example of a method for initial beam pairing during set up of a sidelink unicast link, according to some embodiments. The method shown in FIG. 13 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1302, a UE, such as UE 106, may transmit a sidelink physical channel carrying unicast link establishment messages. The sidelink physical channel may be at least one of a PSCCH or a PSSCH.

At 1304, the UE may transmit sidelink reference signals for beam management. In some instances, the sidelink reference signals for beam management may be transmitted on the same beams used to transmit the sidelink physical channel.

At 1306, the UE may receive, from a neighboring UE, beam reporting.

In some instances, the UE may discontinue, based on receiving the beam reporting, the transmitting of the sidelink reference signals for beam management.

In some instances, the beam reporting may include an indication of the neighboring UE's transmit beam. The neighboring UE's transmit beam may be determined based, at least in part, on the neighboring UE's determination of the UE's transmit beam. In some instances, the neighboring UE's transmit beam may be widened to cover the neighboring UE's receive beam from the UE. In some instances, the neighboring UE may determine the UE's transmit beam based on at least one of a largest reference signal received power (RSRP) measurement of all of the UE's transmit beams that were successfully received at the neighboring UE, a random selection of a transmit beam of the UE from among all of the UE's transmit beams that were successfully received at the neighboring UE, and/or a determination of all of the UE's transmit beams that were successfully received at the neighboring UE. In some instances, the UE may determine using a first indicated beam from the neighboring UE as the UE's transmit beam.

In some instances, a sidelink reference signal for beam management may be a non-standalone SL CSI-RS for beam management. In some instances, a non-standalone SL CSI-RS for beam management identifier may be indicated by SCI of the sidelink physical channel.

In some instances, to transmit sidelink reference signals for beam management, the UE may transmit SL CSI-RSs in dedicated slots. The SL CSI-RS transmissions may be sent with a sidelink control information (SCI) stage 1 and an SCI stage 2 in a physical sidelink control channel (PSCCH). In some instances, the SCI stage 1 may indicate resource reservation information and SL CSI-RS related information. The SL CSI-RS related information may include which resources or symbols in a slot are used for SL CSI-RS transmission and their respective associated beam identifier (ID). In such instances, all the SL CSI-RS resources may be associated with the one beam ID. In some instances, the SCI stage 2 may indicate source ID information and destination ID information. The SCI stage 2 may include a 24-bit source ID and a 24-bit destination ID. In some instances, the SCI stage 2 may further indicate SL CSI-RS related information. In such instances, the SL CSI-RS related information may include which resources or symbols in a slot are used for SL CSI-RS transmission and their respective associated beam ID. Further, all the SL CSI-RS resources are associated with the one beam ID.

In some instances, a sidelink medium access control (MAC) control element (CE) may indicate SL CSI-RS related information. In such instances, SL CSI-RS related information may include which resources or symbols in a slot are used for SL CSI-RS transmission and their respective associated beam ID. Further, all the SL CSI-RS resources may be associated with the one beam ID.

In some instances, SL CSI-RS resources may occupy an entire resource pool. In other instances, SL CSI-RS resources may occupy a first portion of a resource pool and a second portion of the resource pool may be used for a sidelink physical channel. Additionally, a frequency gap may separate the first portion and the second portion. The sidelink physical channel may be at least one of a PSCCH, a PSSCH, and/or a PSFCH.

In some instances, each SL CSI-RS transmission may be within a corresponding sub-channel. The sub-channel may be defined based on a definition of a legacy sub-channel of a PSCCH or a PSSCH or the sub-channel may be defined as smaller than the legacy sub-channel of a PSCCH or PSSCH.

In some instances, a sidelink reference signal for beam forming may be a S-SSB for beam management. In such instances, SCI carried in the sidelink physical channel indicates an S-SSB for beam management index. The dedicated slots may be associated with dedicated slots for transmission of the beam pairing reference signals. In some instances, the association may be pre-defined and a first dedicated slot for beam reporting may occur a pre-defined number of slots after a last dedicated slot for transmission of beam pairing reference signals. In some instances, the associated may be pre-configured and a first dedicated slot for beam reporting occurs a pre-configured gap after a last dedicated slot for transmission of beam pairing reference signals. In some instances, a dedicated slot for beam pairing reference signal transmission may be linked to a dedicated slot for beam reporting. In other instances, multiple dedicated slots for beam pairing reference signal transmissions maybe linked to a dedicated slot for beam reporting. In yet other instances, a dedicated slot for beam pairing reference signal transmission may be linked to multiple dedicated slots for beam reporting.

In some instances, a dedicated slot may include multiple dedicated symbols corresponding to multiple beam pairing reference signal transmissions. In such instances, a mapping between a dedicate symbol and a corresponding beam pairing reference signal transmission may be pre-defined or pre-configured. In addition, automatic gain control (AGC) may be applied to each dedicated symbol. In some instances, a source ID and a destination ID may be transmitted together with a dedicated symbol. In such instances, the source ID and the destination ID may be carried by at least one of a MAC CE, an SCI stage 1, or an SCI stage 2.

In some instances, dedicated slots for beam reporting may occupy a resource pool. In other instances, the dedicated slots for beam reporting may occupy a first portion of a resource pool and a second portion of the resource pool is used for sidelink physical channel transmissions. Additionally, a frequency gap may separate the first portion from the second portion. The sidelink physical channel may be at least one of a PSCCH, a PSSCH, and/or a PSFCH.

In some instances, beam reporting may occur in a physical resource block or in a sub-channel. The sub-channel may be defined based on a definition of a legacy sub-channel of a PSCCH or a PSSCH or the sub-channel is defined as a sub-channel used for beam pairing reference signal transmission.

In some instances, the beam reporting may be PSFCH based and the PSFCH may be carried on a resource associated with a selected beam pairing reference signal resource. In some instances, one physical resource block (PRB) of a PSFCH resource may be associated with one resource of a selected beam pairing reference signal. Additionally, a cyclic shift value may be applied for PSFSCH sequence generation. The cyclic shift value for PSFCH sequence generation may depend, at least in part, on one or more of an ID of the UE or an ID of the neighboring UE. In other instances, multiple PRBs of a PSFCH resource may be associated with one resource of a selected beam pairing reference signal. In such instances, a first PRB among the multiple PRBs may correspond to the neighboring UE and the correspondence may depend, at least in part, on one or more of an ID of the UE or an ID of the neighboring UE.

In some instances, the beam reporting may be PSCCH or PSSCH based and the PSCCH/PSSCH may be carried on a resource associated with a selected beam pairing reference signal resource.

In some instances, the UE may detect, after establishing the sidelink unicast link with the neighboring UE, a triggering condition for transmitting beam failure recovery (BFR) reference signals. Further, in response to the detecting, the UE may transmit BFR reference signals and discontinue the transmitting when at least one recovery condition is satisfied. In some instances, the at least one recovery condition may include the UE receiving a BFR request (BFRQ) from the neighboring UE, the UE receiving a BFR response (BFRR) message from the neighboring UE indicating BFR has been performed, and/or the UE receiving a specified number of consecutive hybrid automatic repeat request (HARQ) feedbacks from the neighboring UE. The specified number may be pre-configured. In some instances, the trigger condition may include at least one of the UE failing to receive HARQ feedback from the neighboring UE in a specified number of consecutive HARQ feedback windows and/or the UE receiving a sidelink BFR request (BFRQ) from the neighboring UE. The specified number may smaller than a threshold for sidelink radio link failure. Additionally, the specified number may pre-configured. In some instances, a BFR reference signal may be a S-SSB for beam management and/or a SL CSI-RS for beam management.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for initial beam pairing prior to set up of a sidelink unicast link, comprising:
determining, by a user equipment device (UE), to set up the sidelink unicast link with a neighboring UE in a first slot;
transmitting, by the UE and during a transmission window for transmitting beam pairing reference signals, beam pairing reference signals to the neighboring UE for beam pairing; and
performing, by the UE, beam pairing with the neighboring UE based on the beam pairing reference signals.

2. The method of claim 1,
wherein the transmission window is defined based on the first slot; and wherein the method further comprises:
determining, by the UE, the transmission window as [n-A1, n-A2], wherein n is a slot number associated with the first slot, and wherein A1 and A2 are determined based, at least in part, on one or more of:
a resource pool configuration;
a resource pool pre-configuration;
a service associated with the sidelink unicast link;
UE's implementation;
channel busy ratio (CBR) of the resource pool; or
CBR of dedicated reference signal resources.

3. (canceled)

4. The method of claim 1,
wherein the transmission window is defined based on a periodicity of transmission of beam pairing reference signals.

5. The method of claim 1,
wherein the beam pairing reference signals comprise sidelink synchronization signal blocks (S-SSBs) for beam management.

6. (canceled)

7. (canceled)

8. The method of claim 5,
wherein a relationship between slots of S-SSBs for beam management and legacy S-SSBs for sidelink synchronization is configured or pre-configured; and
wherein a periodicity of slots of S-SSBs for beam management and legacy S-SSBs for sidelink synchronization is the same.

9. (canceled)

10. The method of claim 5,
wherein S-SSB for beam management resources comprise one resource per slot.

11. The method of claim 10,
wherein the one resource per slot is shared and can be used without resource selection.

12. (canceled)

13. The method of claim 10,
wherein access to the one resource per slot is based on one of a source identifier (ID) or service (ID), and wherein a mapping of one of the source ID or service ID to the one resource per slot is configured or pre-configured.

14. (canceled)

15. The method of claim 5,
wherein S-SSB for beam management resource comprise a plurality of resources per slot;
wherein the plurality of resources per slot is frequency division multiplexed within the slot, time division multiplexed within the slot, or multiplexed in the slot based on a combination of frequency division multiplexing and time division multiplexing; and
wherein, for time division multiplexed resources within the slot, transmission of an S-SSB for beam management comprises a sub-slot operation.

16-89. (canceled)

90. An apparatus, comprising:
a memory; and
at least one processor in communication with the memory and configurated to cause a user equipment device (UE) to perform operations comprising:
determining to set up a sidelink unicast link with a neighboring UE in a first slot;
transmitting, during a transmission window for transmitting beam pairing reference signals, beam pairing reference signals to the neighboring UE for beam pairing; and
performing beam pairing with the neighboring UE based on the beam pairing reference signals.

91. The apparatus of claim 90,
wherein the beam pairing reference signals comprise sidelink (SL(channel state information reference signals (CSI-RSs) for beam management, wherein SL CSI-RSs for beam management resources are configured or pre-configured per resource pool or per sidelink bandwidth part (BWP), and wherein sidelink SL CSI-RS for beam management resources occupy dedicated slots, wherein the dedicated slots are not used for legacy sidelink data transmissions.

92. The apparatus of claim 91,
wherein the sidelink CSI-RS for beam management resources are shared resources, and wherein multiple sidelink CSI-RS for beam management resources are time division multiplexed within each dedicated slot.

93. The apparatus of claim 91,
wherein, when resource selection of sidelink CSI-RS for beam management is based on legacy resource selection procedures for sidelink data transmissions, the at least one processor is further configured to cause the UE to perform operations comprising:
transmitting a sidelink physical channel with one of a sidelink control information (SCI) stage 2 or medium access control (MAC) control element (CE) with a sidelink CSI-RS for beam management to reserves the resource for the sidelink CSI-RS for beam management, wherein the sidelink physical channel comprises one or more of a physical sidelink control channel (PSCCH) or a physical sidelink shared channel (PSSCH), and wherein the sidelink physical channel carries one or more of a source identifier or a destination identifier.

94. The apparatus of claim 91,
wherein resource selection of sidelink CSI-RS for beam management is based on mapping between one or more of a source identifier associated with the UE or service identifier associated with the UE to particular SL CSI-RS for beam management resources.

95. A non-transitory computer readable memory medium storing instructions executable by processing circuitry to cause a user equipment device (UE) to perform operations comprising:
determining to set up a sidelink unicast link with a neighboring UE in a first slot;
transmitting, during a transmission window for transmitting beam pairing reference signals, beam pairing reference signals to the neighboring UE for beam pairing; and
performing beam pairing with the neighboring UE based on the beam pairing reference signals.

96. The non-transitory computer readable memory medium of claim 95,
wherein beam correspondence is assumed between the neighboring UE's transmit beam to the UE the neighboring UE's receive beam from the UE.

97. The non-transitory computer readable memory medium of claim 95,
wherein a transmit beam of the neighboring UE to the UE is wider than a receive beam of the neighboring UE from the UE, wherein the transmit beam covers the receive beam, and wherein the transmit beam comprises an omni-directional beam.

98. The non-transitory computer readable memory medium of claim 95,
wherein, to cause the UE to perform operations comprising performing beam pairing with the neighboring UE comprises, the instructions are further executable by the processing circuitry to cause the UE to perform operations comprising:
receiving, from the neighboring UE, a sidelink physical channel transmission indicating the neighboring UE's identifier (ID) and the UE's ID and a transmit beam of the UE corresponding to one of the UE's beam pairing reference signal transmissions, wherein the sidelink physical channel comprises one or more of a physical sidelink control channel (PSCCH) or a physical sidelink shared channel (PSSCH) ..

99. The non-transitory computer readable memory medium of claim 98,
wherein a transmit beam of the UE uses dedicated resources corresponding to one of the UE's beam pairing reference signal transmissions, and wherein, to cause the UE to perform operations comprising performing beam pairing with the neighboring UE comprises, the instructions are further executable by the processing circuitry to cause the UE to perform operations comprising:
receiving, from the neighboring UE, a physical sidelink feedback channel transmission or sidelink control information (SCI) indicating the neighboring UE's identifier (ID) and the UE's ID.

100. The non-transitory computer readable memory medium of claim 95,
wherein the beam pairing reference signals comprise a sidelink channel state information reference signal (SL CSI-RS); and
wherein, to cause the UE to perform operations comprising transmitting, during a transmission window for transmitting beam pairing reference signals, beam pairing reference signals to the neighboring UE for beam pairing, the instructions are further executable by the processing circuitry to cause the UE to perform operations comprising:
transmitting SL CSI-RSs in dedicated slots.
